(19) United States
(12) Patent Application Publication
(10) Pub. No.: US 2020/0168204 A1
(43) Pub. Date: May 28, 2020

(54) AUTOMATED DRIVING DEVICE, CAR NAVIGATION DEVICE, AND DRIVING ASSISTANCE SYSTEM

(71) Applicant: TOYOTA JIDOSHA KABUSHIKI KAISHA, Toyota-shi (JP)

(72) Inventors: Akira IIJIMA, Nagoya-shi (JP); Hironobu SUGIMOTO, Nagoya-shi (JP); Hiroaki SAKAKIBARA, Nagoya-shi (JP)

(73) Assignee: TOYOTA JIDOSHA KABUSHIKI KAISHA, Toyota-shi (JP)

(21) Appl. No.: 16/580,274

(22) Filed: Sep. 24, 2019

(30) Foreign Application Priority Data
Nov. 27, 2018 (JP) 2018-221441

(51) Int. Cl. G10L 13/04; G10L 13/047; G10L 13/033; G05D 1/00; G01C 21/36

(52) U.S. Cl. CPC G10L 13/043; G10L 13/047; G10L 13/033; G05D 2201/0213; G05D 1/0016; G01C 21/3629; G01C 21/3608; G05D 1/0088

(57) ABSTRACT

An automated driving device adapted to be installed on a vehicle includes a controller that obtains voice output information of a car navigation device installed on the vehicle, and determines voice output information of the automated driving device, based on the obtained voice output information of the car navigation device.

### INCORPORATION BY REFERENCE

The disclosure of Japanese Patent Application No. 2018-221441 filed on Nov. 27, 2018 including the specification, drawings and abstract is incorporated herein by reference in its entirety.

### BACKGROUND

### 1. Technical Field

The disclosure relates to an automated driving device, a car navigation device, and a driving assistance system.

### 2. Description of Related Art

A car navigation device that provides audio guidance on a traveling direction, etc. is disclosed in Japanese Unexamined Patent Application Publication No. 2008-261641 (JP 2008-261641 A). The car navigation device assists a driver in driving in the following manner; after providing audio guidance on a distance to an intersection and a direction of traveling at the intersection, at a location ahead of the intersection, the car navigation device causes the driver to check and enter the direction of traveling at the intersection, and presents the result of comparison between the direction thus entered and the direction of traveling at the intersection, to the driver.

### SUMMARY

In the meantime, automated driving devices have been developed, as a system that assists in driving. Automated driving devices at Level “2” of driving automation, which are predominantly developed at present, are merely able to assist in driving operation, such as steering, acceleration, and deceleration, of the vehicle; thus, the driver needs to monitor a driving situation. Accordingly, the automated driving device is provided with a function of informing the driving situation of the vehicle by voice, as a function of assisting in monitoring of the driving situation.

If the automated driving device as described above is installed on a vehicle on which the car navigation device that performs audio guidance is installed, it is difficult to determine which of the automated driving device and the car navigation device is generating voice, and the driver may be confused by the voice generated.

This disclosure provides an automated driving device, car navigation device, and driving assistance system, which can enhance the degree of certainty with which the driver correctly determines which of the automated driving device and the car navigation device is generating voice.

A first aspect of the disclosure is concerned with an automated driving device adapted to be installed on a vehicle. The automated driving device includes a controller configured to obtain voice output information of a car navigation device installed on the vehicle, and determine voice output information of the automated driving device, based on the obtained voice output information of the car navigation device.

In the first aspect, the controller may be configured to determine the voice output information of the automated driving device, when voices are generated from the car navigation device and the automated driving device at substantially the same time.

In the first aspect, the voice output information may include a form of expression of speech language, and the controller may be configured to set the form of expression included in the voice output information of the automated driving device, to the form of expression that is different from the form of expression included in the obtained voice output information of the car navigation device.

In the first aspect, the voice output information may include a gender of voice, and the controller may be configured to set the gender of voice included in the voice output information of the automated driving device, to the gender of voice that is different from the gender of voice included in the obtained voice output information of the car navigation device.

A second aspect of the disclosure is concerned with a car navigation device adapted to be installed on a vehicle. The car navigation device includes a controller configured to obtain voice output information of an automated driving device installed on the vehicle, and determine voice output information of the car navigation device, based on the obtained voice output information of the automated driving device.

In the second aspect, the controller may be configured to determine the voice output information of the car navigation device, when voices are generated from the automated driving device and the car navigation device at substantially the same time.

In the second aspect, the voice output information may include a form of expression of speech language, and the controller may be configured to set the form of expression included in the voice output information of the car navigation device, to the form of expression that is different from the form of expression included in the obtained voice output information of the automated driving device.

In the second aspect, the voice output information may include a gender of voice, and the controller may be configured to set the gender of voice included in the voice output information of the car navigation device, to the gender of voice that is different from the gender of voice included in the obtained voice output information of the automated driving device.

A driving assistance system according to a third aspect of the disclosure includes an automated driving device adapted to be installed on a vehicle, a car navigation device adapted to be installed on the vehicle, and a control device that controls the automated driving device and the car navigation device. The control device includes a controller configured to obtain voice output information of the automated driving device and voice output information of the car navigation device, and determine the voice output information of at least one of the automated driving device and the car navigation device, based on the obtained voice output information of the automated driving device and the obtained voice output information of the car navigation device.

In the third aspect, the controller may be configured to determine the voice output information of at least one of the automated driving device and the car navigation device, when voices are generated from the automated driving device and the car navigation device at substantially the same time.

In the third aspect, the voice output information may include a form of expression of speech language, and the controller may be configured to determine the form of expression included in the voice output information of at least one of the automated driving device and the car navigation device, such that the form of expression differs between the automated driving device and the car navigation device.

In the third aspect, the voice output information may include a gender of voice, and the controller may be configured to determine the gender of voice included in the voice output information of at least one of the automated driving device and the car navigation device, such that the gender of voice differs between the automated driving device and the car navigation device.

According to the disclosure, it is possible to provide the automated driving device, car navigation device, and driving assistance system, which can enhance the degree of certainty with which the driver correctly determines which of the automated driving device and the car navigation device is generating voice.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view showing the general configuration of a driving assistance system according to a first embodiment and a second embodiment;

FIG. 2 is a flowchart illustrating a procedure of a voice output determining process according to the first embodiment;

FIG. 3 is a flowchart illustrating a procedure of a voice output determining process according to the second embodiment;

FIG. 4 is a view showing the general configuration of a driving assistance system according to a third embodiment; and

FIG. 5 is a flowchart illustrating a procedure of a voice output determining process according to the third embodiment.

### DETAILED DESCRIPTION OF EMBODIMENTS

Some embodiments of the disclosure will be described with reference to the drawings. Devices and parts to which the same reference numerals are assigned in the drawings have the same or similar configurations. A driving assistance system including an automated driving device and a car navigation device according to each embodiment is installed on a vehicle, and assists a driver as a user in driving of the vehicle.

### First Embodiment

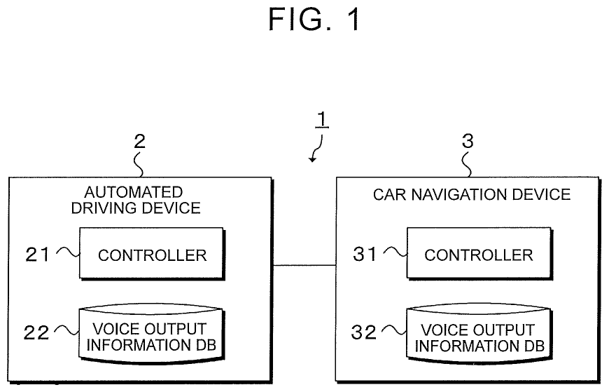

Referring to FIG. 1, the general configuration of a driving assistance system 1 according to a first embodiment will be described. The driving assistance system 1 includes an automated driving device 2 and a car navigation device 3, for example. The automated driving device 2 conforms to Level “2” of driving automation, and has an automated driving assistance function of assisting the driver in driving operation, such as steering, acceleration, and deceleration, of the vehicle, using voice, etc. A known automated driving assistance function may be adopted as appropriate as the automated driving assistance function.

The car navigation device 3 has a navigation function of guiding the driver along a pathway (traveling route) from the current position to a destination, using voice, etc. A known navigation function may be adopted as appropriate as the navigation function.

Each of the automated driving device 2 and the car navigation device 3 includes, for example, a control unit including a central processing unit (CPU) and a memory, operation part, display, speaker, and communication device, as its physical configuration. The CPU executes a given program stored in the memory, so as to implement each function of a controller 21 of the automated driving device 2 and a controller 31 of the car navigation device 3.

The controller 31 of the car navigation device 3 has at least the navigation function as described above.

The controller 21 of the automated driving device 2 has a voice output determining function of determining voice output information, for example, in addition to the automated driving assistance function as described above.

The above-mentioned voice output information includes, for example, set information, such as a form of expression of speech language and a gender of voice, concerning voice output, and audio guidance information concerning a content conveyed by voice. The voice output information may include a voice output command issued when voice is generated.

The above-mentioned forms of expression of speech language include a form to which the subject is given, and a form to which the subject is not given. As the subject, “I”, “We”, or “You” may be used. For example, a message, such as “PROCEED TO THE RIGHT”, of a guidance type represents an expression of the form to which the subject is not given.

The voice output determining function of the controller 21 will be described in detail below.

The controller 21 receives a voice output command of the car navigation device 3 and a voice output command of its own device (i.e., the automated driving device 2).

The controller 21 obtains voice output information of the car navigation device 3. The voice output information can be obtained by (a) receiving voice output information added to the voice output command transmitted from the car navigation device 3, or (b) receiving voice output information transmitted each time the voice output information is updated in the car navigation device 3.

The controller 21 determines whether voices included in the received voice output commands of both devices 2, 3 are generated at substantially the same time.

When the voices are generated at substantially the same time, the controller 21 determines the voice output information of the automated driving device 2, so that the voice output information of the car navigation device 3 and the voice output information of the automated driving device 2 differ from each other. Here, when both pieces of the voice output information are already different from each other, the controller 21 allows voice to be generated based on the existing voice output information as it is, without determining the voice output information of the automated driving device 2.

When the voices are not generated from the devices 2, 3 at substantially the same time, the controller 21 allows voice to be generated based on the existing voice output information as it is.

The voice output information determined by the controller 21 includes, for example, (1) the form of expression of speech language, and (2) the gender of voice. Each case will be described below.

(1) Form of Expression of Speech Language

The controller 21 sets the form of expression of speech language included in the voice output information of the automated driving device 2, to one that is different from the form of expression of speech language included in the voice output information of the car navigation device 3. For example, when the form of expression of speech language included in the voice output information of the car navigation device 3 is the form to which the subject is not given, the controller 21 sets the form of expression of the automated driving device 2 to the form to which the subject is given. In another example, when the form of expression of speech language included in the voice output information of the car navigation device 3 is the form in which “You” is used as the subject, the controller 21 sets the form of expression of the automated driving device 2 to the form in which “I” is used as the subject.

(2) Gender of Voice

The controller 21 sets the gender of voice included in the voice output information of the automated driving device 2, to one that is different from the gender of voice included in the voice output information of the car navigation device 3. For example, when the gender of voice included in the voice output information of the car navigation device 3 is “male”, the controller 21 sets the gender of voice of the automated driving device 2 to “female”.

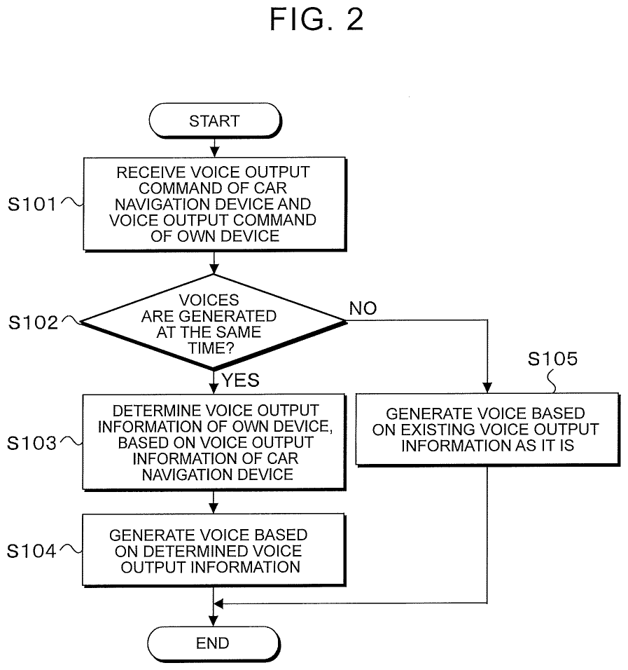

Referring to FIG. 2, the procedure of a voice output determining process executed in the automated driving device 2 will be described below.

Initially, the controller 21 receives a voice output command of the car navigation device 3 and a voice output command of the automated driving device 2 (step S101).

Subsequently, the controller 21 determines whether voices included in the voice output commands of both devices 2, 3 received in step S101 are generated at substantially the same time (step S102).

When the controller 21 determines in step S102 that the voices are generated at substantially the same time (step S102; YES), the controller 21 determines voice output information of the automated driving device 2, based on the voice output information of the car navigation device 3 (step S103).

Subsequently, the controller 21 causes voice to be generated based on the voice output information determined in step S103 (step S104). Then, the voice output determining process is finished.

On the other hand, when the controller 21 determines in step S102 that the voices are not generated at substantially the same time (step S102; NO), the controller 21 allows voice to be generated based on the existing voice output information as it is (step S105). Then, the voice output determining process is finished.

As described above, the automated driving device 2 of the first embodiment obtains voice output information of the car navigation device 3. When voices are generated from the car navigation device 3 and the automated driving device 2 at substantially the same time, the voice output information of the automated driving device 2 can be determined, so that the voice output information, such as the form of expression of speech language, or the gender of voice, differs between the car navigation device 3 and the automated driving device 2.

Thus, the automated driving device 2 according to the first embodiment makes it possible to enhance the degree of certainty with which the driver correctly determines which of the automated driving device 2 and the car navigation device 3 is generating voice.

### Second Embodiment

Referring to FIG. 1, a second embodiment of the disclosure will be described. The driving assistance system 1 according to the second embodiment is different from the driving assistance system 1 according to the first embodiment in that the automated driving device 2 has the voice output determining function in the first embodiment, whereas the car navigation device 3 has the voice output determining function in the second embodiment. Other than this point, the driving assistance system 1 of the second embodiment is identical with that of the first embodiment; thus, the same reference numerals are assigned to corresponding constituent elements, which will not be further described, and only the difference from the first embodiment will be described below.

As shown in FIG. 1, the driving assistance system 1 according to the second embodiment includes the automated driving device 2 and the car navigation device 3, for example, like the driving assistance system 1 according to the first embodiment.

The controller 21 of the automated driving device 2 has at least the automated driving assistance function as described above.

The controller 31 of the car navigation device 3 further has the voice output determining function as described above, for example, in addition to the navigation function as described above. The voice output determining function of the controller 31 will be described in detail below.

The controller 31 receives a voice output command of the automated driving device 2 and a voice output command of its own device (i.e., the car navigation device 3).

The controller 31 obtains voice output information of the automated driving device 2. The voice output information can be obtained by (a) receiving voice output information added to the voice output command transmitted from the automated driving device 2, or (b) receiving voice output information transmitted each time the voice output information is updated in the automated driving device 2.

The controller 31 determines whether voices included in the received voice output commands of both devices 2, 3 are generated at substantially the same time.

When the voices are generated at substantially the same time, the controller 31 determines the voice output information of the car navigation device 3, so that the voice output information of the automated driving device 2 and the voice output information of the car navigation device 3 differ from each other. Here, when both pieces of the voice output information are already different from each other, the controller 31 allows voice to be generated based on the existing voice output information as it is, without determining the voice output information of the car navigation device 3.

When the voices are not generated from the devices 2, 3 at substantially the same time, the controller 31 allows voice to be generated based on the existing voice output information as it is.

The voice output information determined by the controller 31 includes, for example, (1) the form of expression of speech language, and (2) the gender of voice. Each case will be described below.

(1) Form of Expression of Speech Language

The controller 31 sets the form of expression of speech language included in the voice output information of the car navigation device 3, to one that is different from the form of expression of speech language included in the voice output information of the automated driving device 2. For example, when the form of expression of speech language included in the voice output information of the automated driving device 2 is the form to which the subject is given, the controller 31 sets the form of expression of the car navigation device 3 to the form to which the subject is not given. In another example, when the form of expression of speech language included in the voice output information of the automated driving device 2 is the form in which “1” is used as the subject, the controller 31 sets the form of expression of the car navigation device 3 to the form in which “You” is used as the subject.

(2) Gender of Voice

The controller 31 sets the gender of voice included in the voice output information of the car navigation device 3, to one that is different from the gender of voice included in the voice output information of the automated driving device 2. For example, when the gender of voice included in the voice output information of the automated driving device 2 is “female”, the controller 31 sets the gender of voice of the car navigation device 3 to “male”.

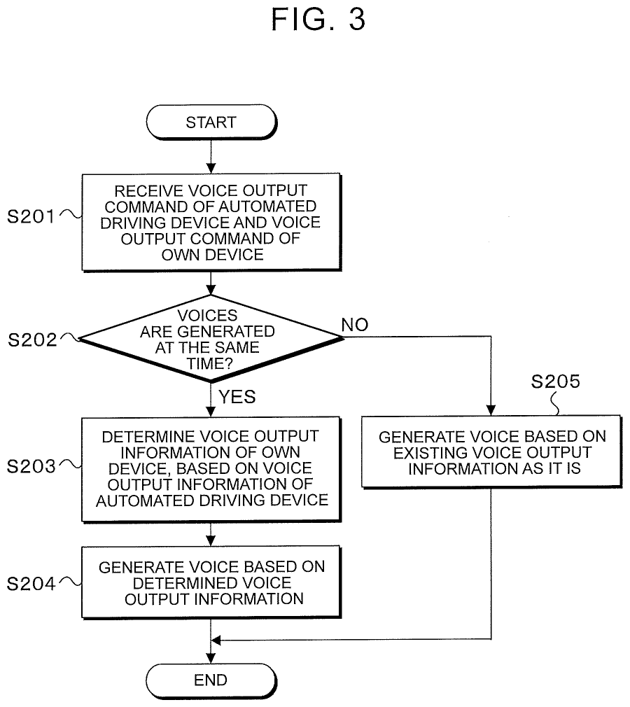

Referring to FIG. 3, the procedure of a voice output determining process executed in the car navigation device 3 will be described below.

Initially, the controller 31 receives a voice output command of the automated driving device 2 and a voice output command of the car navigation device 3 (step S201).

Subsequently, the controller 31 determines whether voices included in the voice output commands of both devices 2, 3 received in step S201 are generated at substantially the same time (step S202).

When the controller 31 determines in step S202 that the voices are generated at substantially the same time (step S202; YES), the controller 31 determines voice output information of the car navigation device 3, based on the voice output information of the automated driving device 2 (step S203).

Subsequently, the controller 31 causes voice to be generated based on the voice output information determined in step S203 (step S204). Then, the voice output determining process is finished.

On the other hand, when the controller 31 determines in step S202 that the voices are not generated at substantially the same time (step S202; NO), the controller 31 allows voice to be generated based on the existing voice output information as it is (step S205). Then, the voice output determining process is finished.

As described above, the car navigation device 3 of the second embodiment obtains voice output information of the automated driving device 2. When voices are generated from the automated driving device 2 and the car navigation device 3 at substantially the same time, the voice output information of the car navigation device 3 can be determined, so that the voice output information, such as the form of expression of speech language, or the gender of voice, differs between the automated driving device 2 and the car navigation device 3.

Thus, the car navigation device 3 according to the second embodiment makes it possible to enhance the degree of certainty with which the driver correctly determines which of the automated driving device 2 and the car navigation device 3 is generating voice.

### Third Embodiment

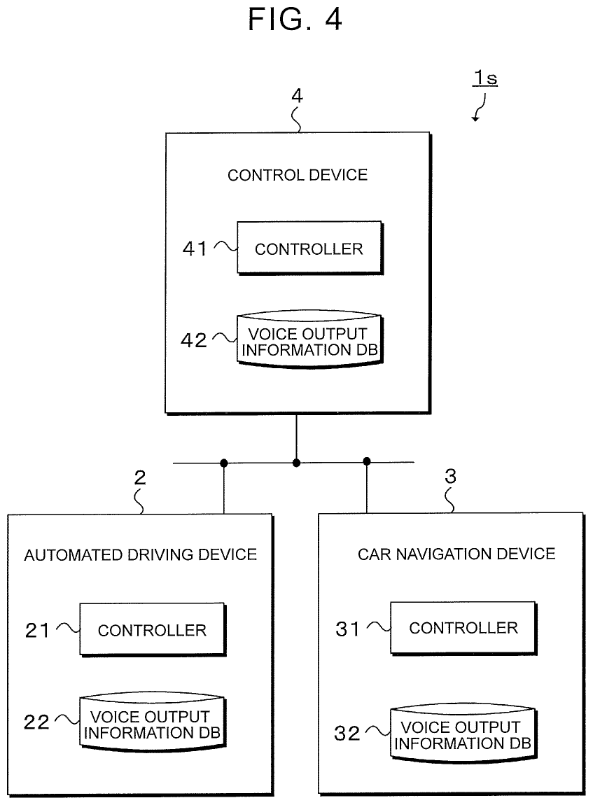

Referring to FIG. 4, a third embodiment of the disclosure will be described. A driving assistance system 1s of the third embodiment is different from the driving assistance system 1 of the above first embodiment in that the driving assistance system Is of the third embodiment further includes a control device 4, and that the automated driving device 2 has the voice output determining function in the first embodiment, whereas the control device 4 has the voice output determining function in the third embodiment. Other than these points, the driving assistance system 1s of the third embodiment is identical with the driving assistance system 1 of the first embodiment. Thus, the same reference numerals are assigned to corresponding constituent elements, which will not be further described, and the differences from the first embodiment will be mainly described below.

As shown in FIG. 4, the driving assistance system Is of the third embodiment includes the automated driving device 2 and the car navigation device 3, for example, like the driving assistance system 1 of the first embodiment, and further includes the control device 4. The automated driving device 2, car navigation device 3, and control device 4 are connected via a bus or communication cables, for example, and are configured to be able to communicate with each other. The control device 4 may be provided in a data center, for example. In this case, the control device 4 is connected with the automated driving device 2 and the car navigation device 3 via a communication network. The communication network may be constructed by appropriately combining a wireless communication network and a wire communication network.

The controller 21 of the automated driving device 2 has at least the automated driving assistance function as described above. The controller 31 of the car navigation device 3 has at least the navigation function as described above.

A controller 41 of the control device 4 has a voice output determining function, for example. The voice output determining function of the controller 41 will be described in detail below.

The controller 41 receives a voice output command of the automated driving device 2 and a voice output command of the car navigation device 3.

The controller 41 obtains voice output information of the automated driving device 2 and voice output information of the car navigation device 3. The voice output information can be obtained by (a) receiving voice output information added to the voice output command transmitted from the automated driving device 2 or car navigation device 3, or (b) receiving voice output information transmitted each time the voice output information is updated in the automated driving device 2 or the car navigation device 3.

The controller 41 determines whether voices included in the received voice output commands of both devices 2, 3 are generated at substantially the same time.

When the voices are generated at substantially the same time, the controller 41 determines the voice output information of the automated driving device 2, so that the voice output information of the automated driving device 2 differs from the voice output information of the car navigation device 3, and sends the voice output information thus determined to the automated driving device 2. The automated driving device 2 causes voice to be generated based on the voice output information received from the control device 4. Here, when both pieces of the voice output information are already different from each other, the controller 41 sends a message indicating this fact to the automated driving device 2, and allows voice to be generated based on the existing voice output information as it is, without determining the voice output information of the automated driving device 2.

When the voices are not generated from the devices 2, 3 at substantially the same time, the controller 41 sends a message indicating this fact to the automated driving device 2. The automated driving device 2 allows voice to be generated based on the existing voice output information as it is.

The voice output information determined by the controller 41 includes, for example, (1) the form of expression of speech language, and (2) the gender of voice. Each case will be described below.

(1) Form of Expression of Speech Language

The controller 41 sets the form of expression of speech language included in the voice output information of the automated driving device 2, to one that is different from the form of expression of speed language included in the voice output information of the car navigation device 3. For example, when the form of expression of speech language included in the voice output information of the car navigation device 3 is the form to which the subject is not given, the controller 41 sets the form of expression of the automated driving device 2 to the form to which the subject is given. In another example, when the form of expression of speech language included in the voice output information of the car navigation device 3 is the form in which “You” is used as the subject, the controller 41 sets the form of expression of the automated driving device 2 to the form in which “1” is used as the subject.

(2) Gender of Voice

The controller 41 sets the gender of voice included in the voice output information of the automated driving device 2, to one that is different from the gender of voice included in the voice output information of the car navigation device 3. For example, when the gender of voice included in the voice output information of the car navigation device 3 is “male”, the controller 41 sets the gender of voice of the automated driving device 2 to “female”.

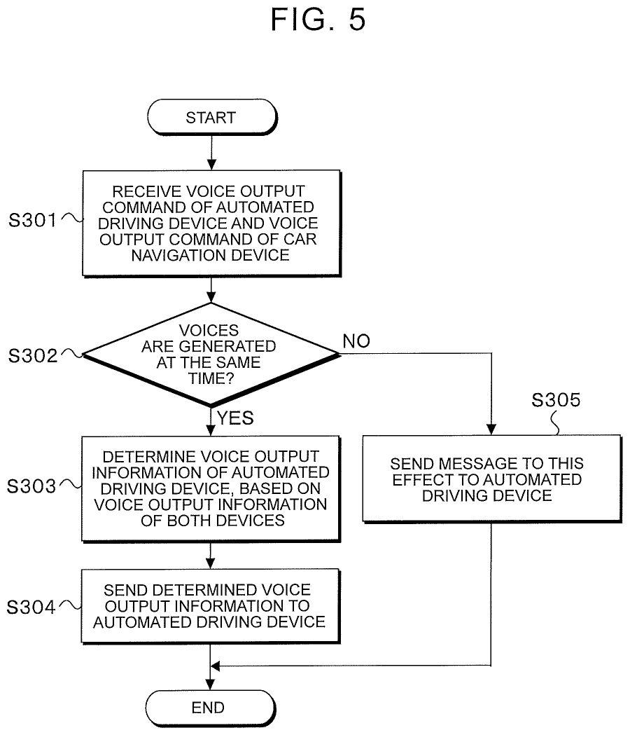

Referring to FIG. 5, the procedure of a voice output determining process executed in the control device 4 will be described below.

Initially, the controller 41 receives a voice output command of the automated driving device 2 and a voice output command of the car navigation device 3 (step S301).

Subsequently, the controller 41 determines whether voices included in the voice output commands of both devices 2, 3 received in step S301 are generated at substantially the same time (step S302).

When the controller 41 determines in step S302 that the voices are generated at substantially the same time (step S302; YES), the controller 41 determines voice output information of the automated driving device 2, based on the voice output information of the automated driving device 2 and the voice output information of the car navigation device 3 (step S303).

Subsequently, the controller 41 sends the voice output information determined in step S303 to the automated driving device 2 (step S304). Then, the voice output determining process is finished.

On the other hand, when the controller 41 determines in step S302 that the voices are not generated at substantially the same time (step S302; NO), the controller 41 sends a message indicating this fact to the automated driving device 2 (step S305). Then, the voice output determining process is finished.

As described above, the driving assistance system 1s of the third embodiment obtains voice output information of the automated driving device 2 and voice output information of the car navigation device 3. When voices are generated from the automated driving device 2 and the car navigation device 3 at substantially the same time, the voice output information of the automated driving device 2 can be determined, so that the voice output information, such as the form of expression of speech language, or the gender of voice, differs between the automated driving device 2 and the car navigation device 3.

Thus, the driving assistance system 1s of the third embodiment makes it possible to enhance the degree of certainty with which the driver correctly determines which of the automated driving device 2 and the car navigation device 3 is generating voice.

In the third embodiment, the controller 41 determines the voice output information of the automated driving device 2, based on the voice output information of the automated driving device 2 and the voice output information of the car navigation device 3. However, the voice output information to be determined is not limited to the voice output information of the automated driving device 2. For example, the controller 41 may determine voice output information of the car navigation device 3, based on the voice output information of the automated driving device 2 and the voice output information of the car navigation device 3. In this case, the controller 41 sends the determined voice output information or a message indicating that the voices are not generated at the same time, to the car navigation device 3. In another example, the controller 41 may determine both the voice output information of the automated driving device 2 and the voice output information of the car navigation device 3.

### MODIFIED EXAMPLE

This disclosure is not limited to the illustrated embodiments, but may be embodied in various other forms, without departing from the principle of the disclosure. Thus, the illustrated embodiments are mere exemplary ones in all points, and should not be interpreted in a limited way. For example, the order of steps in each process as described above may be changed as desired provided that no inconsistency arises in the content of the process, or two or more steps may be executed in parallel.

In each of the illustrated embodiments, it is determined whether voices are generated from the automated driving device 2 and the car navigation device 3 at substantially the same time. However, this determination may be omitted. In this case, when both pieces of voice output information from the automated driving device 2 and the car navigation device 3 are identical with each other, either one of the pieces of voice output information is determined, in a manner according to each embodiment, and voice is generated based on the determined voice output information. When both pieces of voice output information are different from each other, voice may be generated based on the existing voice output information as it is.

What is claimed is:

1. An automated driving device adapted to be installed on a vehicle, the automated driving device comprising a controller configured to obtain voice output information of a car navigation device installed on the vehicle, and determine voice output information of the automated driving device, based on the obtained voice output information of the car navigation device.

2. The automated driving device according to claim 1, wherein the controller is configured to determine the voice output information of the automated driving device, when voices are generated from the car navigation device and the automated driving device at substantially the same time.

3. The automated driving device according to claim 1, wherein:
the voice output information includes a form of expression of speech language; and
the controller is configured to set the form of expression included in the voice output information of the automated driving device, to the form of expression that is different from the form of expression included in the obtained voice output information of the car navigation device.

4. The automated driving device according to claim 1, wherein:
the voice output information includes a gender of voice; and
the controller is configured to set the gender of voice included in the voice output information of the automated driving device, to the gender of voice that is different from the gender of voice included in the obtained voice output information of the car navigation device.

5. A car navigation device adapted to be installed on a vehicle, the car navigation device comprising a controller configured to obtain voice output information of an automated driving device installed on the vehicle, and determine voice output information of the car navigation device, based on the obtained voice output information of the automated driving device.

6. The car navigation device according to claim 5, wherein the controller is configured to determine the voice output information of the car navigation device, when voices are generated from the automated driving device and the car navigation device at substantially the same time.

7. The car navigation device according to claim 5, wherein:
the voice output information includes a form of expression of speech language; and
the controller is configured to set the form of expression included in the voice output information of the car navigation device, to the form of expression that is different from the form of expression included in the obtained voice output information of the automated driving device.

8. The car navigation device according to claim 5, wherein:
the voice output information includes a gender of voice; and
the controller is configured to set the gender of voice included in the voice output information of the car navigation device, to the gender of voice that is different from the gender of voice included in the obtained voice output information of the automated driving device.

9. A driving assistance system comprising:
an automated driving device adapted to be installed on a vehicle;
a car navigation device adapted to be installed on the vehicle; and
a control device that controls the automated driving device and the car navigation device, the control device including a controller configured to obtain voice output information of the automated driving device and voice output information of the car navigation device, and determine the voice output information of at least one of the automated driving device and the car navigation device, based on the obtained voice output information of the automated driving device and the obtained voice output information of the car navigation device.

10. The driving assistance system according to claim 9, wherein the controller is configured to determine the voice output information of at least one of the automated driving device and the car navigation device, when voices are generated from the automated driving device and the car navigation device at substantially the same time.

11. The driving assistance system according to claim 9, wherein:
the voice output information includes a form of expression of speech language; and
the controller is configured to determine the form of expression included in the voice output information of at least one of the automated driving device and the car navigation device, such that the form of expression differs between the automated driving device and the car navigation device.

12. The driving assistance system according to claim 9, wherein:
the voice output information includes a gender of voice; and
the controller is configured to determine the gender of voice included in the voice output information of at least one of the automated driving device and the car navigation device, such that the gender of voice differs between the automated driving device and the car navigation device.
